(19) United States
(12) Patent Application Publication
(10) Pub. No.: US 2020/0067617 A1
(43) Pub. Date: Feb. 27, 2020

(54) Method and system for generating stationary and non-stationary channel realizations of arbitrary length

(71) Applicant: Centro de Investigación y de Estudios Avanzados.., Ciudad de Mexico (MX)

(72) Inventor: Ramón PARRA MICHEL, Jalisco (MX)

(73) Assignee: Centro de Investigación y de Estudios Avanzados del Instituto Politécnico Nacional, Ciudad de Mexico, (MX)

(21) Appl. No.: 16/500,769

(22) PCT Filed: Apr. 5, 2017
(86) PCT No.: PCT/MX2017/000044

§ 371 Date: Oct. 3, 2019

(30) Foreign Application Priority Data
Apr. 4, 2017 (MX) MX/A/2017/004400

(51) Int. Cl. H04B 17/391

(52) U.S. Cl. CPC H04B 17/3912

(57) ABSTRACT

Currently the channel emulation is carried out by means of stationary channel realizations in order to perform the tests and validation of the new data communication schemes. However, the channel models available in the state of the art have only been efficiently used to perform channel simulation using software, leaving its efficient implementation in Hardware still unsolved. The present development details a method and apparatus for performing the channel emulation of time selective scenarios with arbitrary dispersion (channels with both isotropic and non-isotropic arrival angle distributions or channels with asymmetric and non-asymmetric power spectral densities). Likewise, the present development allows generating arbitrarily long channel realizations for channels whose statistics are non-stationary, allowing to emulate real channels. The simulation of stationary and non-stationary channels is performed by concatenating independent sequences and by applying a window to the generated sequences, through a shaping filter that allows this type of model to be implemented in selective time channel emulators in hardware. The sequences are channel realizations that are obtained from any method of generating stochastic processes such as: Sum of orthogonal functions, sum of sinusoids/cisoids, filtering, Fourier transform, etc.

### FIELD OF THE INVENTION

The present invention is related to the field of telecommunications; specifically, to the implementation of time-selective channel emulators to test systems or devices of wireless communication. The proposed generic emulator can be used to generate and inject multiplicative noise into the systems under test.

### BACKGROUND OF THE INVENTION

The constant search for the improvement of data communication schemes due to the growing and massive demand for voice, data and video services by users, creates the need for devices capable of performing the evaluation and validation of the performance of the new communications systems, this with the purpose of helping its soon market launch. The performance measurement equipment required in the design of new wireless communication systems are channel simulators/emulators, which seek to simulate/emulate the actual propagation conditions of a communication channel.

Channel simulators/emulators reproduce propagation environments with temporal, frequency, and/or spatial selectivity, with the aim of distorting signals transmitted in the same way (statistically speaking), than the actual propagation phenomenon. A particular propagation environment is represented by particular statistical functions. Channel simulators/emulators require generating additive and multiplicative noise that resembles realization of the real channels, which are characterized by stochastic processes with particular statistics and correlation functions. The correlation introduced will depend on the distribution of the arrival/departure angles of the propagation paths (rays), which signals near the transmitter and receiver are propagated with; moreover, these angle distributions are directly associated with a given propagation environment or power spectral density.

It is well known that the radio channel has an environment with multipath propagation conditions, which causes the transmitted signal to suffer dispersions, delays and attenuations that, in conjunction with mobility conditions, the signal seen in the receiver suffers from distortions whose statistics change over time. In other words, the radio channel is non-stationary.

Nowadays different models and channel simulators have been proposed to generate impulse responses varying over time, with the aim of reproducing the distortion phenomena seen in a real radio channel. Currently these models and simulators seek to represent the statistics of a real channel, observing that in a short time, the channel behaves as stationary. Therefore, existing channel models and simulators generate channel realizations with stationary statistics.

Likewise, the accuracy of the channel model and the corresponding channel simulator will be determined by the considerations that have been taken about the nature of the distortion sources and their corresponding statistics. With respect to the channel simulator associated with a particular channel model, the accuracy and usefulness of such simulator will be determined by the computational complexity and parameterization scheme used, which will be defined by the type of simulator that is proposed. The existing channel simulators in the literature can be grouped into three categories mainly: those based on the reduction of the number of physical paths (integration schemes), those based on the modeling of the system and those based on non-physical or virtual paths.

Simulators based on physical path integration use baseband representation for channel representation as the sum of complex sinusoids with their respective amplitude, phase and frequency parameters. This method is known as the method of Sum of Sinusoids (SOS) and Sum of complex sinusoids (SOC), of which the main references of these methods are found in [S. Rice, “Mathematical analysis of random noise,” Bell System Technical Journal, vol. 23, pp. 282-232, 1944], [P. Hoeher, “A statistical discrete-time model for the WSSUS multipath channel,” IEEE Transactions on Vehicular Technology, vol. 41, no. 4, pp. 461-468, nov. 1992.], y [M. Pätzold, Mobile Radio Channels, 2nd ed. Wiley, November 2011].

The second category of simulators includes those that conceptualize the channel as a system where the relationship between the input and output of the system itself is sought. Such system can be represented by any time-varying linear stochastic filter that allows producing channel realizations with predefined statistics such as: the desired power spectral density (PSD) and which is associated with the distribution of the angles of arrival (AoA) of trajectories in a moving receiver/transmitter. There are various techniques for obtaining stochastic filter coefficients, for example [J. Michels, P. Varshney, and D. Weiner, “Synthesis of correlated multichannel random processes,” Signal Processing, IEEE Transactions on, vol. 42, no. 2, pp. 367-375, February 1994.] y [K. Baddour and N. Beaulieu, “Autoregressive modeling for fading channel simulation,” IEEE Transactions on Wireless Communications, vol. 4, no. 4, pp. 1650-1662, July 2005. para filtros tipo ARMA, [C. Komninakis, “A fast and accurate Rayleigh fading simulator,” in Proc. IEEE Global Telecommunications Conf. GLOBECOM '03, vol. 6, 2003, pp. 3306-3310] for FIR filters.

The third type of simulators based on non-physical paths, uses a set of orthogonal functions as a basis to expand channel realizations in a given domain such as spatial, frequency or delay domain. This method can use different types of set of base functions such as: those based on polynomials [P. Bello, “Characterization of randomly time-variant linear channels,” vol. 11, no. 4, pp. 360-393, December 1963], orthogonal functions obtained from the eigen-decomposition of the auto correlation function [K.-W. Yip and T.-S. Ng, “Karhunen-loeve expansion of the wssus channel output and its application to efficient simulation,” Selected Areas in Communications, IEEE Journal on, vol. 15, no. 4, pp. 640-646, May 1997], those based on wavelets [R. Parra-Michel, V. Y. Kontorovitch, and A. G. Orozco-Lugo, “Modeling wide band channels using orthogonalizations,” IEICE TRANSACTIONS on Electronics, vol. E85-C, no. 3, pp. 544-551, March 2002], and those based on the Prolates functions [R. Parra-Michel, V. Kontorovitch, and A. Orozco-Lugo, “Simulation of wideband channels with non-separable scattering functions,” in Proc. IEEE International Conference on Acoustics, Speech, and Signal Processing (ICASSP '02), vol. 3, 13-17 May 2002, pp. 2829-2832], [V. Kontorovich, S. Primak, A. Alcocer-Ochoa, and R. Parra-Michel, “Mimo channel orthogonalisations applying universal eigenbasis,” IET Signal Processing, vol. 2, no. 2, pp. 87-96, 2008], among others.

The aforementioned channel simulators (in their three categories), have been designed to reproduce isotropic and non-isotropic propagation environments, but mostly stationary, that is, PSDs where the statistics they try to reproduce are considered and/or assumed to be invariant.

Although these simulators are suitable for generating stationary channel realizations with statistics close to those desired, they really have important defects or problems that must be resolved in order to build a channel emulator that meets the statistics observed in real channels. The problems to be solved consist of:
a) all methods fail to maintain accuracy in approximation of the desired channel statistics,
b) the extension of these channel simulators has not been developed so that they can approximate the non-stationary nature of the channel constructively.

Nowadays, the method based on the sum of sine or cystoid functions (complex exponentials) has become very important as a channel generation technique to test data communication schemes. In these types of models, the sinusoids (or cisoids, SOS/SOC) are parameterized in regards to their gains, frequencies and phases, by means of some parameterization technique.

Within the parameterization techniques (TP) of the models based on SOS/SOC there are two tendencies: those that follow a deterministic parameterization, where the gains, frequencies and phases of the model are fixed throughout the entire simulation interval, and those that follow a stochastic parameterization technique (for example, a Monte Carlo—MC scheme), where the SOS/SOC parameters are randomly assigned within the simulation interval. This last tendency allows simulating more real propagation environments, incorporating the randomness or dynamics of the propagation environment by considering that the Doppler frequencies of the SOS/SOC can be randomly assigned during the simulation process. Among the major contributions in the literature that show examples of SOS/SOC-based channel simulators among which are [F. Ren and Y. Zheng, “A novel emulator for discrete-time MIMO triply selective fading channels,” IEEE Transactions on Circuits and Systems I: Regular Papers, vol. 57, no. 9, pp. 2542-2551, September 2010], [A. Alimohammad, S. Fard, B. Cockburn, and C. Schlegel, “Compact Rayleigh and Rician fading simulator based on random walk processes,” IET Communications, vol. 3, no. 8, pp. 1333-1342, August 2009], [C. Xiao, J. Wu, S.-Y. Leong, Y. Zheng, and K. Letaief, “A discrete time model for triply selective MIMO rayleigh fading channels,” IEEE Transactions on Wireless Communications, vol. 3, no. 5, pp. 1678-1688, 2004] y [X. Cheng, C.-X. Wang, D. I. Laurenson, S. Salous, and A. V. Vasilakos, “New deterministic and stochastic simulation models for non-isotropic scattering mobile-to-mobile Rayleigh fading channels,” Wireless Communications and Mobile Computing, vol. 11, no. 7, pp. 829-842, 2011], where some have their corresponding hardware architecture. In these contributions, different versions of the aforementioned parameterization schemes are observed.

The channel models mentioned so far treat the channel as a stationary version, leaving out the analysis and simulation/emulation of the channel as a non-stationary version, which is representative of a real wireless communications channel.

Likewise, despite the fact that the aforementioned works assume the channel as stationary, they present the important limitation of not guaranteeing continuity in the amplitude of the channel realizations, that is, there is discontinuities in the waveforms as a consequence of the renewal of parameters of the TP used. As a consequence, this causes the appearance of unwanted harmonic components at frequencies other than those found in the PSDs of real channels. Likewise, the updating parameters process at runtime in a channel emulator, generates distortions in the first order functions (probability density function—PDF, cumulative density function—CDF, autocorrelation function—ACF, cross correlation function—CCF, power spectral density—PSD) and second order (level crossing rate—LCR, average duration of fades—ADF) obtained from the realizations of the channel, making it impossible for the models reported in the open literature to be implemented in real channel emulators in a completely and satisfactory way.

Based on the prior art analysis, there are inventions that try to solve similar problems such as the invention of the publication EP2169968 A1, this invention is focused on simulating the performance of a cellular telephone network for technology CDMA or WCDMA. A simulation method is presented to determine the configuration characteristics and performance of a cellular network in terms of its coverage and number of users that a base station can support; a simulation method of a cellular network is proposed for the CDMA IS95 scheme, looking at the network coverage and number of users and base stations.

The invention EP 1401100 A1, is focused on the design of wireless communication systems using the Code Division Multiple Access (CDMA) scheme. Based on the above, both the methods and the architecture of the devices that make up said communication system are presented, while the invention described in this document focuses on the emulation of distortion phenomena in propagation environments.

In the object invention of this document, a new method and communication channel simulation/emulation system for generating stationary and non-stationary channel realizations of arbitrary length is described. The channel realizations guarantee the generation of accurate statistics at PDF, CDF, ACF, LCR, ADF and PSD levels. The new method is based on the concatenation of independent sequences such as those generated through any of the models already discussed previously ensuring continuity in amplitude of the channel embodiments generated.

### BRIEF DESCRIPTION OF THE FIGURES

FIG. 1 shows the impact on the envelope of the process generated using any of the methods described when new parameters are introduced in the generator in order to obtain new realizations in the channel to be emulated.

FIG. 2 is divided into 4 sections identified as 2A, 2B, 2C and 2D, which show the Impact on the results obtained from the ACF, LCR and PSD functions provided from the process generated by some method described above, where the propagation environment is considered with isotropic dispersion (AoA uniformly distributed in the range [0,2pi]). For example, concatenating 4 independent sequences using the SOS/SOC method with the following configuration: a variance equal to σ_{μ}²=1, N=20 and a maximum Doppler frequency fₘₐₓ=100 Hz.

FIG. 3 illustrates the windowing or modulation of the channel realizations given by the technique proposed for stationary channels;

FIG. 4A illustrates the technique of concatenating and windowing channel realizations to generate WSS processes from independent channel realizations obtained through models.

FIG. 4B illustrates the technique of concatenating and windowing channel realizations to generate non-stationary (non-WSS) processes with constant average power from independent channel realizations obtained through models.

FIG. 4C illustrates the technique of concatenating and windowing channel realizations to generate non-stationary (non-WSS) processes with instantaneous power varying over time from independent channel realizations obtained by models.

FIG. 5 shows; the general architecture of apparatus in hardware of the time-selective channel emulator,

FIGS. 6A, 6B, 6C and 6D show comparison results of the ACF of the process generated according to the proposed model that is identified by the equations together (I), (II) and (III):

$$\begin{matrix}{h}_{wcr} ( t ) = {μ}_{1} ( t ) + {μ}_{2} ( t ) , & ( I ) \\ {μ}_{1} ( t ) = {\sum }_{i = - ∞}^{∞} \frac{1}{\sqrt{2}} {x}_{i} ( t ) w ( t - iT - α ) & ( II ) \\ {μ}_{2} ( t ) = {\sum }_{k = - ∞}^{∞} \frac{1}{\sqrt{2}} {x}_{k} ( t ) w ( t - kT - α - T / 2 ) & ( III )\end{matrix}$$

in its stationary version (WSS), which is based on the concatenation of independent stochastic processes and the application of a windowing or modulation with a forming filter. The test parameters are as follows: a method based on TP-MC SOC and considering the parameters σ_{\hat{p}}²=1, N=101 and a maximum Doppler frequency fₘₐₓ=500 Hz.

FIGS. 7A, 7B, 7C, 7D, 7E and 7F show the results obtained from the processes generated according to the proposed model identified in equations (I), (II), (III):

$$\begin{matrix}{h}_{wcr} ( t ) = {μ}_{1} ( t ) + {μ}_{2} ( t ) , & ( I ) \\ {μ}_{1} ( t ) = {\sum }_{i = - ∞}^{∞} \frac{1}{\sqrt{2}} {x}_{i} ( t ) w ( t - iT - α ) & ( II ) \\ {μ}_{2} ( t ) = {\sum }_{k = - ∞}^{∞} \frac{1}{\sqrt{2}} {x}_{k} ( t ) w ( t - kT - α - T / 2 ) & ( III )\end{matrix}$$

in its stationary version WSS, which is based on the concatenation of independent stochastic processes and on the application of a window with a forming filter. The test parameters are as follows: a method based on TP-MC SOC and considering the parameters σ_{\hat{μ}}²=1,N=101 and a maximum Doppler frequency fₘₐₓ=500 Hz. In FIG. 7A the PDF corresponds, in FIG. 7B the CDF corresponds, in FIG. 7C the LCR corresponds, in FIG. 7D the LCR corresponds in decibels (dB), in FIG. 7E the ADF corresponds and in FIG. 7F it corresponds the PSD.

FIGS. 8A and 8B show the concatenation of stochastic processes independent of the proposed model according to equations (I), (II), (III):

$$\begin{matrix}{h}_{wcr} ( t ) = {μ}_{1} ( t ) + {μ}_{2} ( t ) , & ( I ) \\ {μ}_{1} ( t ) = {\sum }_{i = - ∞}^{∞} \frac{1}{\sqrt{2}} {x}_{i} ( t ) w ( t - iT - α ) & ( II ) \\ {μ}_{2} ( t ) = {\sum }_{k = - ∞}^{∞} \frac{1}{\sqrt{2}} {x}_{k} ( t ) w ( t - kT - α - T / 2 ) & ( III )\end{matrix}$$

in its non-stationary version. In FIGS. 8A and 8B, 7 different propagation scenarios are presented, which are concatenated with the window-based model presented in this invention; the scenarios are identified as Window 1 to Window 7 within FIG. 8A.

FIG. 9 shows an example of the evolution of a PSD (statistics of a non-stationary communications channel) with respect to the time corresponding to a real fixed to mobile communications scheme.

FIG. 10 shows an example of the evolution of a PSD (statistics of a non-stationary communications channel) with respect to the time corresponding to a real mobile to mobile communication scheme.

### DETAILED DESCRIPTION OF THE INVENTION

The characteristic details of the method and system for generating stationary and non-stationary channel realizations of arbitrary length, are clearly shown in the following description and in the illustrative drawings provided, serving the same reference signs to indicate the same parts.

### The Realistic Communications Channel Model

A communications channel given by a multipath propagation environment can be approximated by any channel model such as those reported so far in open literature. However, due to the nature of the propagation environment, the physical geography of the terrain should be seen in this channel, as a channel that is not stationary (non-WSS) strictly. The above can be explained by assuming that the channel is composed of multiple paths, modeled in its impulse response by sinusoidal wavefronts, and as a mobile moves, a certain number of sinusoids will appear or disappear; even, some sinusoids of which the channel is formed, may disappear completely; for example, if the user travels through a tunnel during their journey to their destination, this will be seen that the variance of the stochastic process will tend to 0, and as the user leaves the tunnel the process' variance will be increased. Therefore, the time at which the parameters must be maintained (e.g., number of sinusoids, number of eigenfunctions for the case of sum of orthogonal functions, structure and coefficients for the case of filtering-based methods) of a given channel model could depend on a time window which can be scaled by a value that is sensitive to the Lognormal variability of the scenario under study. Due to the above, a more faithful model is one that has the peculiarity that allows each of its configuration parameters (which define the scenario object of this invention) to evolve or update as time passes.

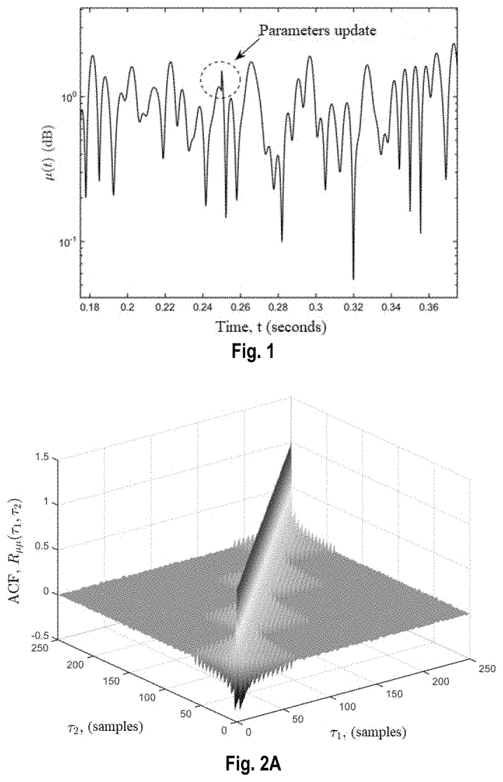

In works previously described in the literature, the impact of these transitions or parameter updates on the models on the communications channel, is not explained. Hence, it is assumed that these types of models are only recommended for versions of software-based channel simulators, where model parameter updates are made so that the system under evaluation does not perceive such transitions as illustrated in FIG. 1. The above is achieved by synchronizing the realization of the channel with the frames of the system under evaluation; that is, the realization of the channel and the plot start synchronously. The above scheme is not practical under a real channel emulation environment (not just simulation), where the physical channel emulator device (implemented by hardware design techniques) cannot have the frame synchronization information.

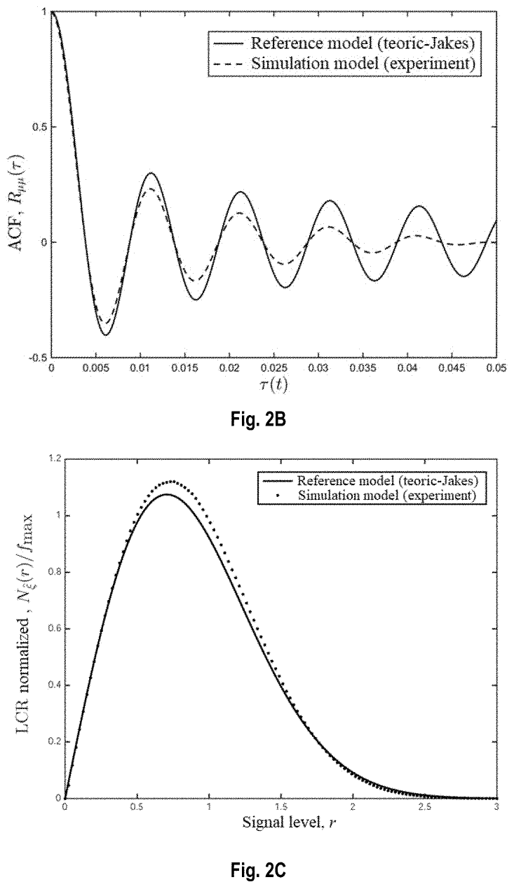

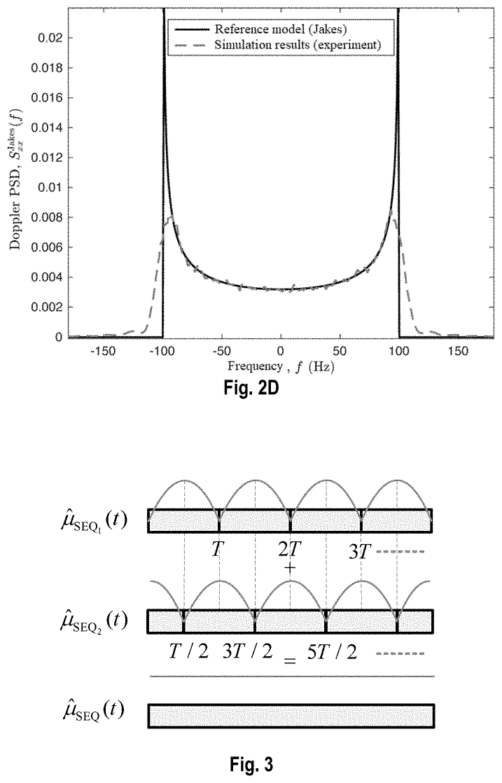

FIGS. 2A, 2B, 2C and 2D show some statistics produced on the communications channel when an arbitrarily long process is formed from the concatenation of 4 sequences (or channel realizations) that have been obtained through any of the techniques described above. In FIG. 2A the desired theoretical reference curves are represented by solid black lines for the results obtained from ACF, LCR and PSD. It is clearly possible to observe that the concatenated sequences are correlated with each other as seen in FIGS. 2A and 2B. In addition, abrupt variations (changes in signal level that occur in times less than the coherence time of the channel) in the envelope of the resulting process, where the independent sequences are concatenated, make the LCR looks modified as shown in the FIG. 2C with the dotted line curve and which is identified as a simulation model (experiment). Likewise, the PSD of the generated process suffers widening, impacting on the desired maximum Doppler frequency on the desired channel to be reproduced as can be seen in FIG. 2D with the dotted line curve and which is identified as simulation results (experiment). From FIGS. 2A, 2B, 2C and 2D, it can be seen that the concatenated process is not an realization of the channel that is stationary and consequently ergodic. Even using in this way any of the models presented in channel emulators, unwanted distortions would be introduced in the channel emulator apparatus and, consequently, it would cause the functions generated through this type of channel models to diverge of theoretical reference curves; therefore, a different channel would be emulated than was originally desired.

Time-Sensitive Channel Simulatorlemulator Conceptualized from the Concatenation of Independent Channel Realizations.

After the analysis presented in the previous section on the impact of the processes' parameters update, it is commented that, today there are no implementable models to generate non-stationary channels in their entirety (non-WSS, non-Wide-Sense Stationary). This is due to the fact that current channel models do not have sufficient parameterization to incorporate all the uncertainties of the communications channel. That is, there is no channel model that is sensitive to:
1) Lognormal variability of the scenario under study,
2) the evolution of the parameters of the stochastic processes generated as time passes,
3) to maintain or eliminate just some certain frequencies of which the channel model is formed and
4) to have as random the time window in which the parameters of the models are maintained.

Until now, one way to facilitate the emulation of the communications channel has been to make the approach to the channel through channel realizations that are stationary WSS in very short simulation times. The time-selective channel emulation technique presented in this invention allows simulating/emulating communication channels considering the uncertainties of the communication channel described above (channel emulation that is non-stationary or non-WSS). However, the proposed channel model can be simplified to generate WSS realizations from the concatenation of independent sequences.

### Proposed Channel Model

The proposed channel generation/emulation method considers the implementation of the following generic channel model according to equations (I), (II) and (III), which lead to a process that is stationary, continuous and ergodic in short time:

$$\begin{matrix}{h}_{wcr} ( t ) = {μ}_{1} ( t ) + {μ}_{2} ( t ) , & ( I ) \\ {μ}_{1} ( t ) = {\sum }_{i = - ∞}^{∞} \frac{1}{\sqrt{2}} {x}_{i} ( t ) w ( t - iT - α ) & ( II ) \\ {μ}_{2} ( t ) = {\sum }_{k = - ∞}^{∞} \frac{1}{\sqrt{2}} {x}_{k} ( t ) w ( t - kT - α - T / 2 ) & ( III )\end{matrix}$$

where α is an initial random phase uniformly distributed in the interval

$$( \frac{- T}{2} , \frac{T}{2} )$$

of the sequence to generate, w(□) is a function (shaping filter) of size equivalent to the time window of Tseconds, xᵢ(t) y xₖ(t), are independent complex stochastic processes with predefined statistics corresponding to the processes μ₁(t) y μ₂(t), respectively.

Later, it is demonstrated mathematically that by implementing (I) with (II) and (III) in a channel simulator/emulator, an infinite duration process with exact desired statistical functions can be achieved. Clarifying, this model allows to implement a method of generating stochastic processes that makes possible the development of real channel emulators through hardware or software, or other technologies, based on non-stationary/ergodic channel realizations.

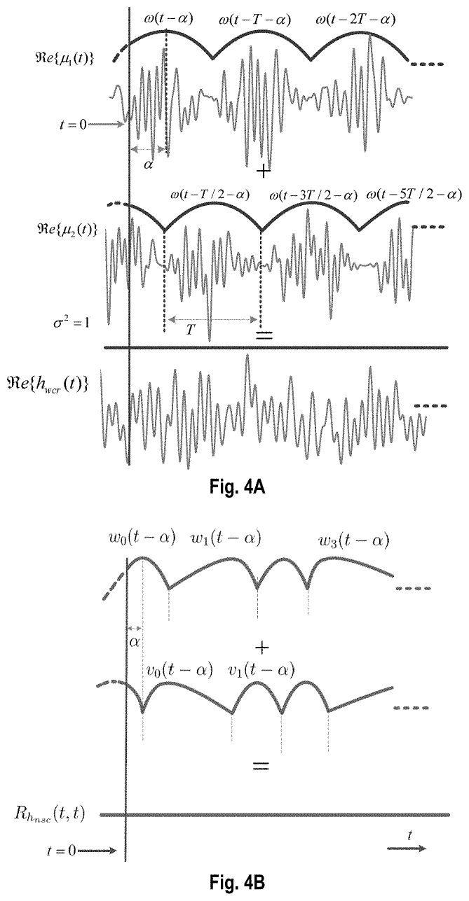

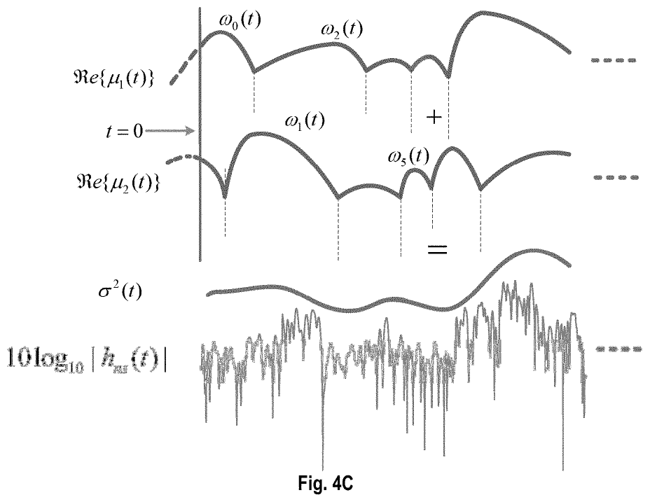

The generic channel model set together in equations (I), (II) and (III) is implemented (in a channel emulator) by means of a channel emulator apparatus through the simulation/emulation method of channel presented in FIG. 3 and FIG. 4A. In this method, the generated process h_{wcr}(t) will be formed from the sum of two complex independent sequences μ₁(t) y μ₂(t), where one of the independent sequences (in this particular case is the sequence μ₂(t) for illustrative purposes) is out of phase during T seconds, where T is the duration of the independent realizations of the channel (or time window of the model). In this time window T, the independent processes xᵢ(t) and xₖ(t) that make up each of the two sequences will be evolving (or updating) in terms of their parameters (gains, frequencies or phases) as time elapses during the simulation or emulation process of the desired channel.

It is emphasized that each of the realizations xᵢ(t) y xₖ(t) that integrate independent sequences μ₁(t) y μ₂(t), can be obtained through channel embodiments using any of the techniques mentioned above (sum of functions, filtering, sum of orthogonal functions) or any other technique. Likewise, it is commented that due to the nature or parameterization of these non-stationary models, the implementation/emulation of channels associated to environments with isotropic dispersion or environments with non-isotropic dispersion can be achieved.

As already shown through FIG. 1 and FIGS. 2A, 2B, 2C and 2D, the independent processes that make up the sequences μ₁(t) y μ₂(t), when they do not consider the proposed windowing scheme and the use of the random variable α, they generate discontinuities in the sample positions where the new realizations of the channel were made, which affect the functions of the channel under simulation/emulation. However, to accomplish that the achievements obtained from the process h_{wcr}(t) being stationary and ergodic in a short time and does not contain discontinuities in the generated process (mitigation of the problem of low statistical quality of the generated sequence), it is necessary that the processes xᵢ(t) y xₖ(t) are windowed by a shaping filter w(□) that contain dependence on a random variable α as proposed in the model represented by equations (I), (II) and (III). The action or impact of the filter w(□) y α about the sequences μ₁(t) and μ₂(t) can be clearly observed in FIG. 4A.

The proposed model with equations (I), (II) and (III) can be represented jointly by:

$${h}_{wcr} ( t ) = {\sum }_{i = - ∞}^{∞} \frac{1}{\sqrt{2}} {x}_{i} ( t ) w ( t - iT + α ) + {\sum }_{k = - ∞}^{∞} \frac{1}{\sqrt{2}} {x}_{k} ( t ) w ( t - kT + α - T / 2 ) , \qquad ( IV )$$

Where to ensure that the process h_{wcr}(t) is stationary in wide sense, continuous, with ergodicity in a short time and whose instantaneous power in each of its realizations is not affected by the renewal of the parameters, it can be generated if the following requirements are met, as a possible solution:
All processes xᵢ(t) and xₖ(t) they are stationary processes with the same autocorrelation function Rₓₓ(Δt).
The phase parameter α is a random variable with uniform distribution in the interval

$$( \frac{- T}{2} , \frac{T}{2} ) .$$

The window w(t) is a function that is defined in

$$( \frac{- T}{2} , \frac{T}{2} )$$

and must satisfy

$${\sum }_{n = - ∞}^{∞} E \{ {w}^{2} ( t - nT / 2 + α ) \} = 2.$$

Following the aforementioned conditions, it is feasible to demonstrate mathematically (which will be done below) that the autocorrelation function that will be obtained at the end of the generation scheme of h_{wcr}(t) will be defined by

$${R}_{{h}_{wcr}} ( Δ t ) + {R}_{xx} ( Δ t ) \{ \frac{1}{T} w ( Δ t ) ⊗ w ( - Δ t ) \} ,$$

where ⊗ is the well-known convolution operation. In addition, the average channel power is Rₓₓ(0)=σₓ², that is, the variance of each of the random variables that make up the processes xᵢ(t) and xₖ (t), while the windowing function can be obtained from w(t)=\sqrt{βG(t)}, being G(f) a function that meets Nyquist's first criterion of zero intersymbolic interference (in the frequency domain), and β is just a normalization factor.
Generation of Arbitrarily Long Non-Stationary Processes (Non-WSS) with Constant Power.

The proposed model with equations (I), (II) and (III) can be parameterized in a different way in order to generate arbitrarily long processes non-stationary (non-WSS) with constant power, thus allowing to generate a stochastic process with constant average power with statistics that can evolve over time if desired, like the ACF and therefore the PSD, among others. Therefore, a non-stationary process h_{nsc}(t) with constant average power can be formed from the sum of two processes yᵢ(t) y yₖ (t) with statistics that may be different and with the same average power σ_{y}², and with a set of windows wᵢ(t) and vₖ (t) which can represent the beginning and end of a scenario with specific statistics that can be maintained for more or less time than in other scenarios at different times. For what you have:

$${h}_{nsc} ( t ) = {\sum }_{i = - ∞}^{∞} {y}_{i} ( t ) {w}_{i} ( t - α ) + {\sum }_{k = - ∞}^{∞} {y}_{k} ( t ) {v}_{k} ( t - α ) , \qquad ( V )$$

where the windows wᵢ(t) and wₖ(t) they must satisfy the condition

$${\sum }_{i = - ∞}^{∞} {w}_{i}^{2} ( t - α ) + {\sum }_{k = - ∞}^{∞} {v}_{k}^{2} ( t - α ) = 1$$

and α is a random variable that in this case serves to smooth the transition between scenarios. Therefore, as time passes processes with windows are obtained wᵢ(t) and vₖ (t) of different duration with statistics may or may not vary over time, as seen in FIG. 4B and FIG. 9.
Generation of Arbitrarily Long Non-Stationary Processes (Non-WSS) with Power Varying Over Time.

The proposed model with equations (I), (II) and (III) can be parameterized in a different way in order to generate arbitrarily long processes Non-stationary (Non-WSS) with instantaneous power that varies over time σ_{y}² (t), thus allowing to generate a stochastic process with statistics that evolve over time allowing, like the ACF and therefore the PSD, among others. Therefore, a non-stationary process h_{nsc}(t) with time varying power can be formed from the sum of two processes yᵢ(t) and yₖ(t) whose instantaneous power σ_{y}²(t) is determined by the statistics defined in each window wᵢ(t) and vₖ(t) according to the index i- and k-window corresponding to a scenario. These windows wᵢ(t) and vₖ(t) represent the beginning and end of a scenario with specific statistics with instantaneous power σ_{y}² (t), and which allow to reproduce the Lognormal behavior of a channel. Then we have the model:

$${h}_{nsc} ( t ) = {\sum }_{i = - ∞}^{∞} {y}_{i} ( t ) {w}_{i} ( t - α ) + {\sum }_{k = - ∞}^{∞} {y}_{k} ( t ) {v}_{k} ( t - α ) \qquad ( VI )$$

where the Windows wᵢ(t) and vₖ (t) must meet a certain power profile variant over time

$${\sum }_{i = - ∞}^{∞} {w}_{i}^{2} ( t - α ) + {\sum }_{k = - ∞}^{∞} {v}_{k}^{2} ( t - α ) = {σ}_{y}^{2} ( t )$$

and α It is a random variable that in this case serves to smooth the transition between scenarios. FIG. 4C shows the example of the generation of a non-stationary stochastic process with instantaneous power varying over time.
Demonstration that the requirements of the parameters set forth in equations (I) (II) and (III) for the processes that integrate the summation, the window and the random variable α, allow to generate a continuous, stationary and ergodic process in a short time.

Given a stochastic process expressed as

$$μ ( t ) = {\sum }_{i = - ∞}^{∞} {x}_{i} ( t ) w ( t - iT + α ) ,$$

then its autocorrelation is defined as:

$${R}_{μμ} ( {t}_{1} , {t}_{2} ) = {\sum }_{i = - ∞}^{∞} {\sum }_{l = - ∞}^{∞} E \{ {x}_{i} ( {t}_{1} ) {x}_{l} ( {t}_{2} ) \} \times E \{ {w}_{i} ( {t}_{1} - iT + α ) {w}_{l} ( {t}_{2} - lT + α ) \} , \qquad ( VII )$$

applying the expected value you have:

$${R}_{μμ} ( {t}_{1} , {t}_{2} ) = {\sum }_{i = - ∞}^{∞} {R}_{{xx}_{i}} ( {t}_{1} , {t}_{2} ) E \{ {w}_{i} ( {t}_{1} - iT + α ) {w}_{l} ( {t}_{2} - lT + α ) \} , \qquad ( VIII )$$

where the phase parameter α is independent of t and all processes are decorrelated for i≠l. Doing t₁-t₂=Δt, and selecting among all the possible options of the PDF functions of α, the uniform PDF, this results in the following:

$${R}_{μμ} ( {t}_{2} + Δ t , {t}_{2} ) = {\sum }_{i = - ∞}^{∞} {R}_{{xx}_{i}} ( {t}_{2} + Δ t , {t}_{2} ) \times \frac{1}{T} {\int }_{α = - T / 2}^{T / 2} w ( {t}_{2} + Δ t - iT + α ) w ( {t}_{2} - iT + α ) d α . \qquad ( IX )$$

With all the processes xᵢ(t) being stationary with the same ACF self-relation function, and noting that the integral in the equation does not change over time, that is, it is always independent of the value of t₂, then it is clear that the process has a constant ACF function. This can be obtained simply by evaluating the equation to t₂=, resulting in the evaluation of i=0, and finally having the ACF of a stationary process:

$${R}_{μμ} ( Δ t ) = {R}_{{xx}_{0}} ( Δ t ) \{ \frac{1}{T} {\int }_{α = - T / 2}^{T / 2} w ( α + Δ t ) w ( α ) d α \} . \qquad ( X )$$

Limiting w(αt) in the interval [−T/2,T/2), the value of the integral is kept out the limits |T/2] will always be zero, thus allowing you to change your limits to −∞,∞ without modifying the result. Considering also that all processes xᵢ(t) are stationary with the same statistics, then we have Rₓₓ_{ᵢ}(Δt)=Rₓₓ(Δt). With these prior considerations, the ACF function of a stationary process (X) is defined as:

$${R}_{μμ} ( Δ t ) = {R}_{xx} ( Δ t ) \{ \frac{1}{T} {\int }_{α = - ∞}^{∞} w ( α + Δ t ) w ( α ) d α \} . \qquad ( XI )$$

The term between braces { } can be organized as the deterministic correlation of two continuous functions. Defining ⊗ as the convolution operator, it allows equation (XI) to be expressed as:

$${R}_{μμ} ( Δ t ) = {R}_{xx} ( Δ t ) \{ \frac{1}{T} w ( Δ t ) ⊗ w ( - Δ t ) \} . \qquad ( XII )$$

To ensure that the generated process is stationary, it is necessary to show that the generated process is of constant average m, this is:

$$E \{ μ ( t ) \} = E \{ {\sum }_{i = - ∞}^{∞} {x}_{i} ( t ) {w}_{i} ( t - iT + α ) \} = m . \qquad ( XIII )$$

Being the parameter α independent of all processes xᵢ(t), then (XIII) results in:

$$E \{ μ ( t ) \} = {\sum }_{i = - ∞}^{∞} E \{ {x}_{i} ( t ) \} E ( {w}_{i} ( t - iT + α ) \} = m , \qquad ( XIV )$$

All processes are stationary with the same statistics, so E{xᵢ(t)}=mₓ. In addition, these processes are disjoint and being concatenated, form a constant function resulting in:

$$E \{ μ ( t ) \} = {m}_{x} {\sum }_{i = - ∞}^{∞} E ( {w}_{i} ( t - iT + α ) \} = m , \qquad ( XV )$$

Changing the operators of hope and summation we have:

$$E \{ μ ( t ) \} = {m}_{x} E \{ {\sum }_{i = - ∞}^{∞} {w}_{i} ( t - iT + α ) \} = m . \qquad ( XVI )$$

However. due to the definition of the function wᵢ(t), it has to

$${\sum }_{i = - ∞}^{∞} {w}_{i} ( t - iT + α ) = W ( t - α ) ,$$

i.e., a periodic and out of phase function with a period equal to T. Therefore, its average over a period is always constant, regardless of the time it is averaged, that is:

$$E \{ {W}_{i} ( t - α ) \} = \frac{1}{T} {\int }_{α = t - \frac{T}{2}}^{t - \frac{T}{2}} W ( t - α ) d α = {m}_{w} . \qquad ( XVII )$$

Therefore E{μ(t)}=mₓm_{w}, and therefore the process is of constant average.

Note that the demonstration of stationarity was done to μ₁(t), but the same demonstration applies to μ₂(t)

In this way, when defining a channel h_{wcr}(t) as the sum of two processes μ₁(t) and μ₂(t) as:

$${h}_{wcr} ( t ) = {\sum }_{i = - ∞}^{∞} \frac{1}{\sqrt{2}} {x}_{i} ( t ) w ( t - iT + α ) + {\sum }_{k = - ∞}^{∞} \frac{1}{\sqrt{2}} {x}_{k} ( t ) w ( t - kT + α - T / 2 )$$

and considering that the processes xᵢ(t) and xₖ(t) are decorrelated but with the same ACF function, then the average channel power is:

$${R}_{{h}_{wcr}} ( t , t ) = \frac{{σ}_{x}^{2}}{2} {\sum }_{i = - ∞}^{∞} E \{ {w}^{2} ( t - iT + α ) \} + \frac{{σ}_{x}^{2}}{2} {\sum }_{l = - ∞}^{∞} E \{ {w}^{2} ( t - lT + α - T / 2 ) \} , \qquad ( XVIII )$$

where Rₓₓ(0)=σₓ². The windows have no impact on the resulting average power when they do not satisfy:

$${\sum }_{i = - ∞}^{∞} E \{ {w}^{2} ( t - iT + α ) \} + {\sum }_{l = - ∞}^{∞} E \{ {w}^{2} ( t - lT + α - T / 2 ) \} = 2 , \qquad ( XIX )$$

which can be grouped into a single equation as

$${\sum }_{n = - ∞}^{∞} E \{ {w}^{2} ( t - nT \text{/} 2 + α ) \} = 2. \qquad ( XX )$$

A simple solution is given by the change the operator of Hope and the order of the summation, and remembering that the phase α has a uniform PDF:

$${\sum }_{n = - ∞}^{∞} E \{ {w}^{2} ( t - nT \text{/} 2 + α ) \} = E \{ {\sum }_{n = - ∞}^{∞} {w}^{2} ( t - nT \text{/} 2 + α ) \} , \\ = \frac{1}{T} {{\int }^{T / 2}}_{α = - T / 2} \{ {\sum }_{n = - ∞}^{∞} {w}^{2} ( t - nT \text{/} 2 + α ) \} d α = 2. \qquad ( XXI )$$

Clearly, a particular solution is a window that satisfies:

$${\sum }_{n = - ∞}^{∞} E \{ {w}^{2} ( t - nT \text{/} 2 + α ) \} = 2.$$

This solution has been considered due to the fact that this restriction falls on the following criteria: A window that satisfies this requirement can be obtained from a function G(f) which meets Nyquist's first criterion of zero intersymbolic interference (in the frequency domain), that is w(t)=\sqrt{βG(t)} where β is a normalization factor. Noting that it is not the only solution given the restrictions, however, it is the simplest solution given the extensive and well-known work of Nyquist.

### Technique for Generating Independent Realizations for Stationary and Non-Stationary Channels

To check the statistical quality of the processes obtained with the proposed generation model, in this invention, equations (I), (II) and (III) are implemented through a channel emulation system. In this sense, it is emphasized that the processes xᵢ(t) and xₖ(t) to be used to achieve the implementation of equations (I), (II) and (III) can come from any of the techniques already presented and analyzed. However, as an example, in this invention the functionality of the model presented in equations (I), (II) and (III) in an emulator apparatus with the windowing technique using the generation of independent stochastic processes using TP techniques is shown −MC SOC. In this sense, the processes xᵢ(t) and xₖ(t) will be generated through the hardware implementation of the equation (IV):

$${x}_{i} ( t ) = {\sum }_{n = 1}^{N} {c}_{i , n} exp ( 2 π {f}_{i , n} t + {θ}_{i , n} ) \qquad ( XXII )$$

where c_{i,n} are the gains of the model defined as constant amounts equal to

$${c}_{i , n} = {σ}_{x}^{2} \sqrt{\frac{1}{N} ,}$$

where σₓ² is the variance of the processes to be generated (parameter that can be configured to include Lognormal variability) and N is the number of functions or cisoids (sum of complex exponentials). Phases θ_{i,n} are random variables uniformly distributed over 0,2π] and Doppler frequencies f_{i,n} form a set of independent random variables. Each Doppler frequency f_{i,n} update, i.e., every time that a window of duration T has elapsed (which may be random if you want to generate non-stationary processes), is “carried out by means of a realization” and f_{i,n} is calculated through the following functional transformation identified as equation (V):

f_{i,n}=F_{f}⁻¹(σₓ²uₙ), 0≤uₙ<1 (XXIII)

for n=1, . . . , N, where uₙ is a uniformly distributed variable over (0,2π], y F_{y}⁻¹(⋅) is the inverse of the cumulative power spectral density function (ICPF), identified as equation (IV):

F_{f}(f)□∫_{-∞}^{f}Sₓₓ(z)dz (XXIV)

with Sₓₓ(f) denoting the Doppler PSD of the desired channel to be simulated. For example, for a von Mises distribution of the AoA, the Doppler PSD (or simply PSD) of xᵢ(t) is given by:

$${S}_{xx}^{VM} ( f ) • {\int }_{- ∞}^{- ∞} {r}_{xx} ( τ ) exp ( - j 2 πτ ) d τ == \frac{{σ}_{x}^{2} {e}^{κ cos ( {ψ}_{0} ) f \text{/} {f}_{max}}}{π {f}_{max} {I}_{0} ( κ ) \sqrt{1 - {( f \text{/} {f}_{max} )}^{2}}} cos h ( κsin ( {ψ}_{0} ) \sqrt{- 1 {( f \text{/} {f}_{max} )}^{2}} ) \qquad ( XXV )$$

where κ>0 is a concentration parameter that can be associated with the angular dispersion of the channel, ψ₀ is the average of the AoA, I₀(□) is the modified Bessel function of the first kind and zeroth order, and fₘₐₓ is the maximum Doppler frequency on the stage under consideration. The preference to implement stochastic models based on MC (SOS/SOC TP-MC) as proposed in equation (XXII), is because through equations (XXIII) and (XXIV) you have the possibility to perform generation of propagation environments with isotropic dispersion, and also to have the ability to reproduce scenarios associated with environments with non-isotropic dispersion.

### Method of Generating Arbitrarily Long Stationary and Non-Stationary Channel Realizations

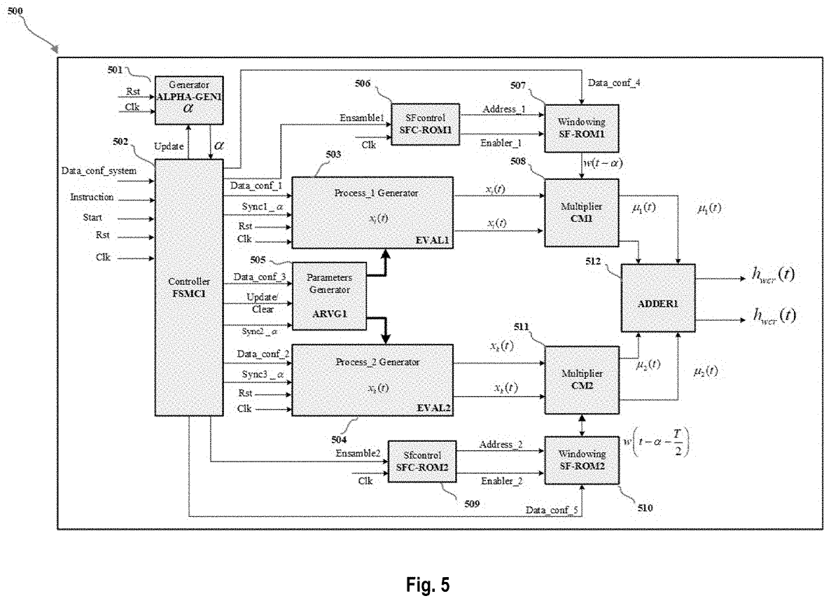

Hereafter, the method is presented as a contribution of this invention for the generation of arbitrarily long sequences from channel realizations. In order that the proposed channel model in (I), (II) and (III) in this development can be represented as a real channel emulator on a software or hardware platform. In FIG. 5, it is shown the architecture of the general system (500) of the time-selective channel emulator (or commonly known as flat fading channel o frequency non-selective fading channel).

In order to be able to generate the arbitrarily long sequences both stationary and non-stationary, the following factors must first be defined:

1.—It is defined the parameters of the channel model which are comprised of: the density or set of Doppler power spectral densities that are desired to be approximated for a stationary or non-stationary channel, as well as the maximum or maximum Doppler frequencies fₘₐₓ that will be reproduced throughout the generation process; also it is defined:
a) In the case of generating arbitrarily long stationary and ergodic stationary processes, the power is defined σₓ² of the independent processes to generate xᵢ(t) and xₖ(t).
b) In the case of generating arbitrarily long non-stationary processes with constant average power, the power is defined σ_{y}² of the independent processes to be generated yᵢ(t) and yₖ(t).
c) In the case of generating arbitrarily long non-stationary processes with instantaneous power varying over time, the instantaneous power is defined σ_{y}² of each of the independent processes to generate yᵢ(t) and yₖ(t) throughout the simulation process; that in conjunction with the windows wᵢ(t) and vₖ (t) a power profile is accomplished

$${\sum }_{n = - ∞}^{∞} {w}_{i}^{2} ( t - α ) + {\sum }_{k = - ∞}^{∞} {v}_{k}^{2} ( t - α ) = {σ}_{y}^{2} ( t ) .$$

2.—It is defined the technique or set of techniques for generating independent stochastic processes xᵢ(t) and xₖ (t), and in the case of non-stationary processes yᵢ(t) and yₖ(t), of those already presented (number of sinusoids/cisoids, number of eigenfunctions for the case of sum of orthogonal functions, structure and coefficients for the case of filtering-based methods, etc.), as well as their corresponding parameters according to the method used.

3.—It is defined the type/shape and duration of the window or filter w(□) according to the final statistics that you want to approximate ACF, LCR, ADF, PSD, etc. and that meets the requirements indicated:
a) In the case of generating arbitrarily long stationary and ergodic processes the window w(t) is a function that is defined in

$$( \frac{- T}{2} , \frac{T}{2} )$$

and must satisfy

$${\sum }_{n = - ∞}^{∞} E \{ {w}^{2} ( t - nT \text{/} 2 + α ) \} = 2 ,$$

as well as the sales function can be obtained
from w(t)=\sqrt{βG(t)}, and the normalization factor is defined β.
b) In the case of generating arbitrarily long non-stationary processes with constant average power, it is considered the windows wᵢ(t) and vₖ(t) which its form and duration may vary throughout the simulation time and must satisfy the condition

$${\sum }_{i = - ∞}^{∞} {w}_{i}^{2} ( t - α ) + {\sum }_{k = - ∞}^{∞} {v}_{k}^{2} ( t - α ) = 1.$$

c) In the case of generating arbitrarily long non-stationary processes with instantaneous power varying over time, it is considered the windows wᵢ(t) and vₖ(t) which its form and duration may vary throughout the simulation time and must satisfy the condition

$${\sum }_{i = - ∞}^{∞} {w}_{i}^{2} ( t - α ) + {\sum }_{k = - ∞}^{∞} {v}_{k}^{2} ( t - α ) = {σ}_{y}^{2} ( t ) .$$

Once all the points required for the generation of arbitrarily long sequences are established, the architecture seen in FIG. 5 is parameterized according to said previously defined factors. In this way, based on this architecture, the generation method is described below:

4.—The general architecture (500) proposed consists of eleven essential blocks (501) to (512) and that together they serve to generate a stationary and non-stationary stochastic process (WSS and non-WSS respectively) of infinite duration with high statistical quality in the generated samples. The general architecture (500), contains a finite state machine FSMC1 (502) which in its initial stage allows the initial parameterization of each of the blocks (503), (504), (505), (507) and (510) according to the parameters of the channel model that were defined by means of the signals Data_Conf_1, Data_Conf_2, Data_Conf_3, Data_Conf_4 y Data_Conf_5; likewise it controls in a synchronized way the data flow of each of the essential blocks to obtain the arbitrarily long sequences.

5.—Once the initialization stage is finished, the state machine FSMC1 (502) takes the phase parameter as the start of generation reference a of the generator module ALPHA-GEN1 (501) to define the starting operation of the modules (503) to (512) from the signaling given by Sync1_α, Sync2_α and Sync3_α. Subsequently, the control module FSMC1 (502) enable the generation and delivery of block parameters ARVG1 (505) by means of the signal Update/Clear to the blocks EVAL1 (503) y EVAL2 (504) corresponding to the generation technique of any of the models presented (for example, number of sinusoids/cisoids, number of eigen-functions for the case of sum of orthogonal functions, structure and coefficients for the case of filtering-based methods, etc.) during each independent realization, this with the objective of generating the processes xᵢ(t) and xᵢ(t) in the case of the generation of ergodic stationary processes; or the processes yᵢ(t) and yₖ(t) for the generation of non-stationary processes considering that the latter, require the parameters corresponding to the set of statistics that will be reproduced throughout the simulation process.

6.—The forming filter blocks SF-ROM1 (507) and SF-ROM2 (510), store the values corresponding to a filter w(□) that through the blocks SFC-ROM1 (506) and SFC-ROM2 (509) generate access values from the signaling given by Ensamble1 and Ensamble2, which in turn are defined from the phase parameter α. Therefore, at runtime it is accessed, through Address_1 and Address_2, to the window values w(□) according to the offset that corresponds to them by means of the signals Enabler_1 and Enabler_2.
a) In the case of generating arbitrarily long stationary and ergodic stationary processes the values of the window w(t) that are stored, are obtained from w(t)=\sqrt{βG(t)}, and which will be generated periodically throughout the simulation process.
b) In the case of generating arbitrarily long non-stationary processes with constant average power, a set of windows is considered wᵢ(t) and vₖ(t) in a different way and/or duration which are stored in the blocks SF-ROM1 (507) and SF-ROM2 (510) and that will be generated over the simulation time as foreseen in step 3.b.
c) In the case of generating arbitrarily long non-stationary processes with instantaneous power varying over time, a set of windows is considered wᵢ(t) and vₖ(t) in a different way and/or duration, and that obey a profile of instantaneous power that varies over time σ_{y}²(t). Such set is stored in the blocks SF-ROM1 (507) and SF-ROM2 (510) and will be generated over the simulation time as provided in step 3.c.
7.—In the case of generating stationary and ergodic processes, the window corresponding to the phase and quadrature components of the independent processes xᵢ(t) and xₖ(t) is applied by means of the blocks that perform the multiplication CM1 (508) and CM2 (511). On the other hand, in the case of generating non-stationary processes the window is applied to the processes yᵢ(t) and yₖ(t). As a result at the output of the multipliers CM1 (508) and CM2 (511), it has the sequences μ₁(t) and μ₂(t), properly weighted and outdated as defined at the beginning of the stationarity analysis.

8.—Subsequently, the phase and quadrature components of the sequences μᵢ(t) and μ₂(t) are added through the adder ADDER1 (512).

9.—Finally, the arbitrarily long sequence of selective noise in time is the final result h_{wcr}(t) in the case of generating stationary and ergodic processes, the process is obtained instead h_{nsc}(t) in the case of generating non-stationary processes with constant instantaneous or variant power over time as previously defined.

### Description of the System that Implements the Proposed Channel Model

In order that the channel model proposed in this development can be represented as a real channel emulator in Hardware, FIG. 5 shows the general architecture (500) of the time-selective channel emulator (or commonly known as flat fading channel o frequency non-selective fading channel) able to implement equations (I) via (II) and (III). The description given below applies directly to the cases of generating arbitrarily long non-stationary processes with constant average power, and with time varying power.

The proposed architecture consists of eleven essential blocks (501 to 512) that in conjunction they generate either a stationary or non-stationary stochastic process (WSS and non-WSS, respectively) of infinite duration with high statistical quality in the generated samples.

The general architecture (500) shown in FIG. 5, it contains a finite state machine that performs general control of the architecture (502) identified as controller FSMC1. The blocks (503) identified as Process_1 Generator EVAL1 and (504) identified as Process_2 Generator EVAL2, they implement the model presented in equation (II). The block (505) identified as Parameters Generator ARVG1, performs the parameter update of any of the models presented (eg, number of sinusoids/cisoids, number of eigenfunctions for the case of sum of orthogonal functions, structure and coefficients for the case of filtering-based methods, etc.) during each independent realization. The block (507) identified as filter or windowing filter SF-ROM1, stores the values corresponding to a filter for the windowing shaping of the phase and quadrature components of the sequence xᵢ(t). At runtime, the values of this ROM are read using the memory addresses generated by the block (506) identified as SFC-ROM1, to be finally transferred to the multiplier CM1 (508) and get the windowed process μ₁(t). This same procedure is performed to apply the windowing shape to the phase and quadrature components of the sequence xₖ(t) using the blocks (510) identified as filter or windowing filter SF-ROM2, the component (509) identified as SFC-ROM2 and the component (511) identified as a multiplier CM2 in order to obtain the sales process μ₂(t). The phase and quadrature components of the sequences μ₁(t) and μ₂(t) are added through the adder ADDER1 (512).

Description of the Main Components within FIG. 5.

### EVAL1 y EVAL2

The component (503) identified as EVAL1 is a block that implements a model as one of the generation techniques described above. Therefore, the component (503) generates two colored Gaussian random variables, which will be scaled by means of a combinational multiplier CM1 (508). Because the component (503), performs the generation of a stochastic process that must be parameterized in some way. The component (502), sends parameterization information, which is stored in internal RAM in this block. The configuration is received serially through the input “Data_conf_1”. The signal Sync1_α is received once the fₛTₛ samples have been generated, where f^{s} is the sampling frequency of the desired process and Tₛ=T. Likewise, the signal Sync1_α is an indication for the component (503) start a new independent realization xᵢ(t). Also, at this moment the component (503) receives random Gaussian variables to be used in the various methods through the component (505), to implement future independent realization xᵢ(t). The component (504) EVAL2, perform the same procedure previously described, but to generate the colored Gaussian samples corresponding to the processes xₖ(t), which will now be scaled by the combinational multiplier (511) CM2. Now the configuration from the component (502), will arrive at the component (504) through the entrance “Data_conf_2”.

### ARVG1

The component (505) identified as ARVG1 is a block that performs the updating of parameters of any of the generation techniques presented (for example, number of sinusoids/cisoids, number of eigenfunctions for the case of sum of orthogonal functions, structure and coefficients for the case of methods based on filtered, etc.). Likewise, this block provides random Gaussian variables to the components (503) and (504) respectively, for channel model implementation.

### SF-ROM1 and SF-ROM2

The component (507) identified as SF-ROM1 and the component (510) identified as SF-ROM2 are two ROM memories that store the discretized shaping filter w(t−iT−α) and w(t−iT−α−T/2), respectively. In the initialization stage, the samples of the shaping filter w(□) are previously loaded to these memories through the signals Data_Conf_4 y Data_Conf_5. In the generation process, the filter samples w(□) are transferred to (508) to perform the scaling of the Gaussian random variables from (503), while the filter samples are transferred to (511) to perform the scaling of the Gaussian random variables from (504). The inputs “Address_1” and “Address_2” provided from the blocks (506) and (509) perform the manipulation of (507) and (510).

### ADDER1

The component (512) identified as ADDER is a complex combinational adder responsible for implementing the sum of the sequences μ₁(t) coming from (508) and μ₂(t) coming from (511). Likewise, (512) generates the phase and quadrature components of the desired process to be generated h_{wcr}(t)

### FSMC1

The component (502) identified as FSMC1 is a state machine that controls the entire architecture (500). It is interconnected with the modules (501, 503, 504, 505, 506 y 509). The control machine (502), in its initial stage it performs the configuration and initialization of the block parameters (503, 504, 505, 506 y 509). Moreover, it uses the phase parameter α given by the phase generator module (501) to define the temporary scheme of generation of the modules (503-512).

### ALPHA-GEN1

The component (501) identified as ALPHA-GEN1 is a parameter generator block α which is an initial random phase evenly distributed in the interval

$$( \frac{- T}{2} , \frac{T}{2} ) ,$$

which delivers a realization of the phase α to the control module (502) to define the temporary scheme of generation of the modules (503 to 512).
Results in the Generation of Selective Channels in WSS Time (or with Flat Fading) Applying the Method and Apparatus Proposed in the Present Invention.

In order to demonstrate the accuracy and quality of the functions generated by the channel generation method through the initial equation shown below, the WSS process channel emulation results are detailed.

The results of the functions have been obtained considering the following test parameters for a stochastic process generator based on MC techniques (TP-MC SOC): a variance equal to αₓ²=1, a maximum Doppler frequency equal to fₘₐₓ=500 Hz and a number of cisoids equal to N=(2×fₘₐₓ×Tₛ)+1=(2×500×0.1)+1=101 and a configuration in the block ARVG1 (505) to emulate an isotropic dispersion environment by configuring equation (XXV) with a couple of parameters equal to (κ=0, ψ₀=0).

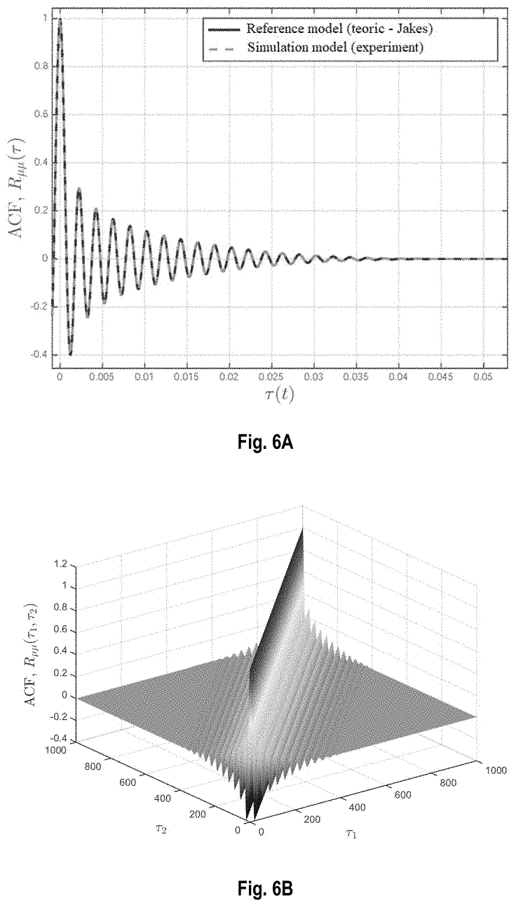

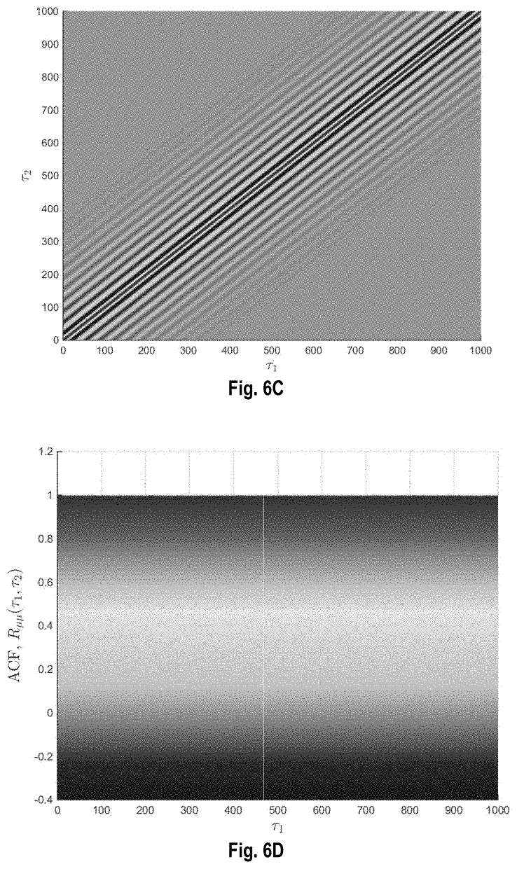

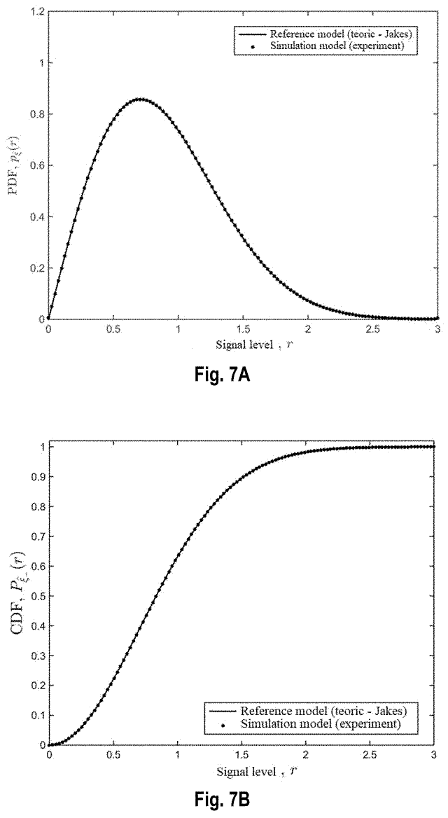

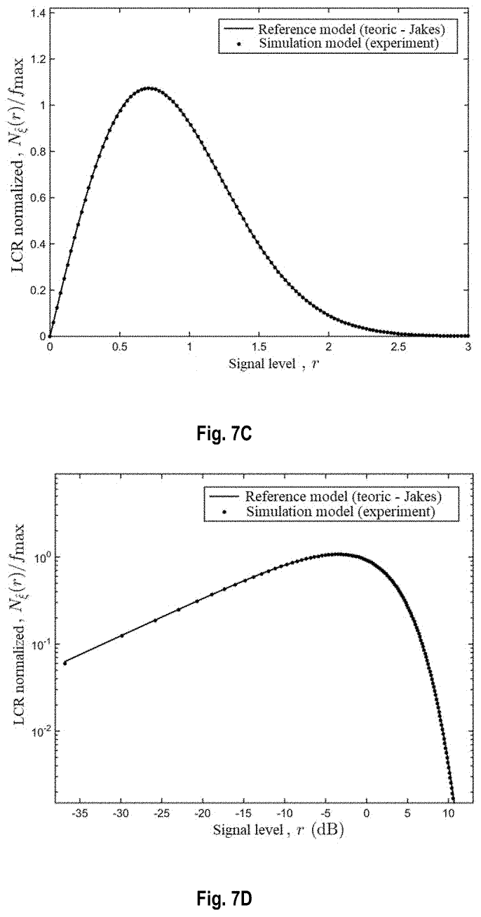

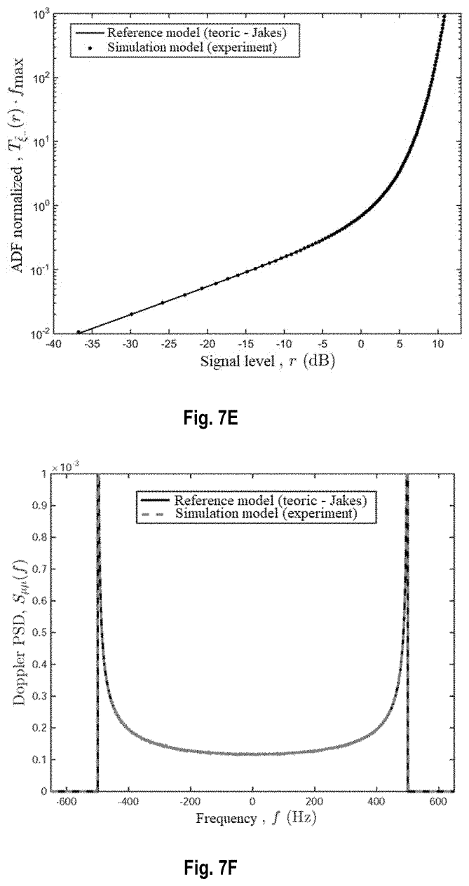

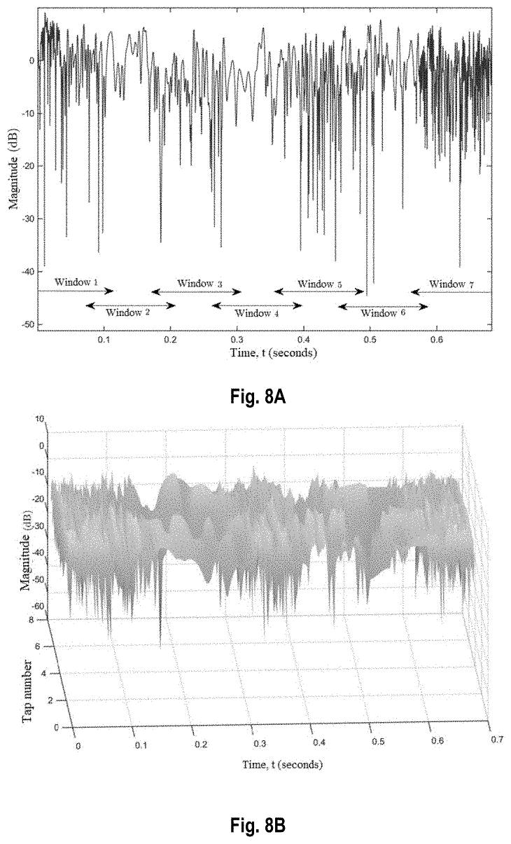

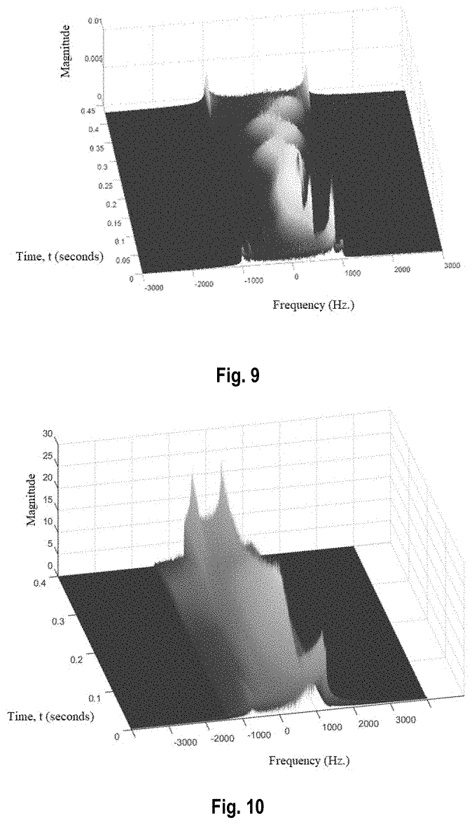

FIGS. 6A, 6B, 6C and 6D show different perspectives of the autocorrelation function of the stochastic process generated through equations (I), (II) and (III). It can be seen that the proposed generation method or technique solves the problem of stationarity in the concatenation of independent processes generated from TP-MC SOC. Likewise, it is verified that generating processes through equations (I), (II) and (III), the problem of low statistical quality in the ACF is mitigated according to FIGS. 2A and 2B. In addition, it can be seen that now the process generated from equations (I), (II) and (III) is also WSS.

On the other hand, FIGS. 7A, 7B, 7C, 7D, 7E and 7F show the first and second order functions obtained from the envelope of the processes generated through equations (I), (II) and (III). It can be seen from FIG. 7A, that the PDF of the generated samples (solid points) converge perfectly with the theoretical reference model curve (solid line). In FIG. 7B, the process CDF is observed and in FIG. 7C and FIG. 7D the generated CSF. In FIG. 7E, the accuracy regarding the convergence of the generated ADF can be seen. Finally, FIG. 7F shows the PSD of the processes generated (dashed lines) and from this figure it can be seen that the processes generated are ergodic.

The present invention has been described in its preferred embodiment, however, it will be apparent to those skilled in the art, that a multitude of changes and modifications of this invention can be made, without departing from the scope of this invention.

Results in the Generation of Non-WSS Time-Selective Channels (or with Flat Fading) Applying the Method and Apparatus Proposed in the Present Invention.

This section presents the considerations for the generation of non-stationary channel realizations where the statistics of the channel vary as time goes by. The results of the emulation of channels with non-stationary statistics are also shown. Once more, using the method of generation through equation (I), the accuracy and quality in the channel embodiments can be demonstrated.

To corroborate the proposed model of equations (I), (II) and (III) for this invention, FIG. 8A and FIG. 8B show an example of non-stationary channel realizations whose statistics evolve over time. FIG. 9 shows an example of the power spectral density. In FIGS. 8A and 8B, seven different propagation scenarios are presented, which are concatenated with the window-based model presented in this invention. Likewise, FIG. 9 shows an example of the evolution of a PSD (statistics of a non-stationary communications channel) with respect to the time corresponding to a real fixed to mobile communications scheme, and finally, FIG. 10 shows an example of the evolution of a PSD (statistics of a non-stationary communications channel) with respect to the time corresponding to a real mobile to mobile communications scheme.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A time-selective channel emulator system implemented by concatenating independent sequences to generate stationary and non-stationary channel realizations of arbitrary length through the model
$${h}_{wcr} ( t ) = {μ}_{1} ( t ) + {μ}_{2} ( t ) , \\ {u}_{1} ( t ) = {\sum }_{i = - ∞}^{∞} \frac{1}{\sqrt{2}} {x}_{i} ( t ) w ( t - iT - α ) , \\ {μ}_{2} ( t ) = {\sum }_{k = - ∞}^{∞} \frac{1}{\sqrt{2}} {x}_{k} ( t ) w ( t - kT - α - T \text{/} 2 ) ,$$
where α is a uniformly distributed initial random phase of
$$( \frac{- T}{2} , \frac{T}{2} ) ,$$
likewise w(□) is a shaping filter equivalent to the time window of T seconds and which must meet the following requirements for the generation of arbitrarily long stationary and ergodic sequences:
All processes xᵢ(t) and xₖ (t) are stationary processes with the same autocorrelation function Rₓₓ(Δt), the average power of the channel is Rₓₓ(0)=σₓ², i.e., the variance of each of the random variables that make up the processes xᵢ(t) and xₖ(t),
The phase parameter α is a random variable with uniform distribution in the interval
$$( \frac{- T}{2} , \frac{T}{2} ) ,$$
The window w(t) is a function that is defined in
$$( \frac{- T}{2} , \frac{T}{2} )$$
and must satisfy
$${\sum }_{n = - ∞}^{∞} E \{ {w}^{2} ( t - nT / 2 + α ) \} = 2.$$
where the sales function can be obtained from w(t)=\sqrt{βG(t)}, being G(f) a function that meets Nyquist's first criterion of zero intersymbolic interference (in the frequency domain), and β is just a normalization factor,
The window w(□) is a function that is defined in
$$( \frac{- T}{2} , \frac{T}{2} )$$
and determine the autocorrelation function for a stationary process such as
$${R}_{{h}_{μμ}} ( Δ t ) = {R}_{xx} ( Δ t ) \{ \frac{1}{T} w ( Δ t ) ⊗ w ( - Δ t ) \} ,$$
where ⊗ is the well-known convolution operation,
Likewise, the processes xᵢ(t) and xₖ(t) are stochastic processes that are performed in the system that comprises:
a) One or a plurality of controllers for general system control,
b) One or a plurality of parameter generators α that perform the update of the phase values of each process realization μ₁(t) and μ₂(t),
c) One or a plurality of stochastic process generators for the implementation of the generation technique of independent stochastic processes xᵢ(t) and xₖ(t) (number of sinusoids/cisoids, number of eigenfunctions for the case of sum of orthogonal functions, structure and coefficients for the case of filtering-based methods, etc.), as well as their corresponding parameters according to the method used, as an example the model
$${x}_{i} ( t ) = {\sum }_{n = 1}^{N} {c}_{i , n} exp ( 2 π {f}_{i , n} t + {θ}_{i , n} ) ,$$
through process generators where c_{i,n} are the gains of the model defined as constant, equal to
$${c}_{i , n} = {σ}_{x}^{2} \sqrt{\frac{1}{N}} ,$$
where σₓ² it is the variance of the processes to be generated (parameter that can be configured to include Lognormal variability) and N is the number of functions or cisoids (sum of complex exponentials), the phases θ_{i,n} are random variables uniformly distributed over (0, 2π] and Doppler frequencies f_{i,n} form a set of independent random variables,
d) One or a plurality of parameter generators that update the parameters of any of the previous models,
e) One or a plurality of shaping or windowing filters to store the values corresponding to a filter for shaping the phase and quadrature components of the processes xᵢ(t) and xₖ(t),
f) One or a plurality of memories for the storage of the generated values product of the previous models,
g) One or a plurality of multiplier devices related to the process generating devices and the forming or window filters established in the numeral d),
h) One or a plurality of summing components which sum the phase and quadrature components of the sequences μ₁(t) and μ₂(t).

2. The generating components of stochastic processes xᵢ(t) and xₖ(t) according to claim 1 are implemented according to the methodology for generating stochastic processes such as: the method of sum of sinusoids/cisoids, orthogonal base expansion, filtering, inverse Fourier transform, or any other methodology.

3. The emulator system according to claim 1 characterized because any random variable generation method can be used that provides variables with certain desired statistics such as the correlation function or Doppler power spectral density.

4. A method for a time-selective channel emulator system implemented by concatenating independent sequences to generate stationary and non-stationary channel realizations of arbitrary length which includes the following steps:
a) The parameters of the channel model are defined, which are comprised of: the density or set of Doppler power spectral densities that are wanted to be approximated, as well as the maximum or maximum Doppler frequencies fₘₐₓ; it is also defined the variance equal to σₓ² of independent sequences,
b) It is defined the technique of generating independent stochastic processes xᵢ(t) and xₖ(t) (number of sinusoids/cisoids, number of eigenfunctions in the case of sum of orthogonal functions, structure and coefficients in the case of filtering-based methods, etc.), as well as their corresponding parameters according to the method used; as an example the model is implemented
$${x}_{i} ( t ) = {\sum }_{n = 1}^{N} {c}_{i , n} exp ( 2 π {f}_{i , n} t + {θ}_{i , n} ) ,$$
through process generators,
c) It is defined the type/shape and duration of the window or filter w(□) according to the final statistics that you want to approximate ACF, LCR, ADF, PSD, etc.,
d) Once all the points necessary for the generation of arbitrarily long sequences are obtained, it is initialized/parameterized the architecture comprising at least the following components:
i. One or a plurality of controllers for general system control,
ii. One or a plurality of parameter generators α that perform the update of the phase values of each process realization μ₁(t) and μ₂(t),
iii. One or a plurality of stochastic process generators for the implementation of the generation technique of independent stochastic process xᵢ(t) and xₖ(t) (number of sinusoids/cisoids, number of eigenfunctions for the case of sum of orthogonal functions, structure and coefficients for the case of filtering-based methods, etc.), as well as their corresponding parameters according to the method used, as an example the model
$${x}_{i} ( t ) = {\sum }_{n = 1}^{N} {c}_{i , n} exp ( 2 π {f}_{i , n} t + {θ}_{i , n} ) ,$$
through process generators where c_{i,n} are the gains of the model defined as constant amounts equal to
$${c}_{i , n} = {σ}_{x}^{2} \sqrt{\frac{1}{N}} ,$$
where σₓ² is the variance of the processes to be generated (parameter that can be configured to include Lognormal variability) and N is θ_{i,n} are random variables uniformly distributed over (0, 2π] and Doppler frequencies f_{i,n} form a set of independent random variables,
iv. One or a plurality of parameter generators that update the parameters of any of the previous models,
v. One or a plurality of shaping or windowing filters to store the values corresponding to a filter for shaping the phase and quadrature components of the processes xᵢ(t) and xₖ (t),
vi. One or a plurality of memories for the storage of the generated values product of the previous models,
vii. One or a plurality of multiplier devices related to the process generating devices and the forming or window filters established in the numeral d),
viii. One or a plurality of summing components which sum the phase and quadrature components of the sequences μ₁(t) and μ₂ (t).
e) Once the initialization stage is finished, the state machine that controls the entire system architecture specified in the numeral d), takes the phase parameter α as the start of generation reference of the parameter generator module α,
f) The parameter update is carried out by means of parameter generators during each independent realization,
g) For the use of shaping or windowing filters w(□) the values corresponding to a filter are stored for shaping to the phase and quadrature components of the sequence xᵢ(t) and xₖ(t),
h) At runtime, the values of this ROM are read using the memory addresses,
i) The values are finally transferred to a complex multiplier,
j) This same procedure is performed to apply the windowing scheme to the phase and quadrature components of the sequence xᵢ(t) and xₖ(t), using shaping or windowing filters to a complex multiplier,
k) Finally, the phase and quadrature components of the sequences μ₁(t) and μ₂(t) are added through the adder,
l) Finally, the arbitrarily long sequence of selective noise in time is the final result h_{wcr}(t).

5. Method according to claim 2, to emulate a WSS time-selective channel by means of a controller comprising: generating a WSS channel from independent channel sequences with predefined statistics, considering the initial phase of the time window as random, assuming time windows constant over time.

6. Method according to claim 2, to emulate a WSS time-selective channel by means of a controller comprising: generating a WSS channel from independent channel sequences with predefined statistics, where the statistics such as the correlation function and the Doppler power spectrum density converge exactly with the reference models thus achieving ergodicity.

7. Method according to claim 2, in the case of emulating a non-WSS time-selective channel with constant average power by a controller to generate a Non-WSS channel from independent channel sequences with predefined statistics, and which requires the consideration of the following points:
a) A non-stationary process h_{nsc}(t) with constant average power can be formed from the sum of two processes yᵢ(t) and yₖ(t) with statistics that may be different and with the same average power σ_{y}², and with a set of windows wᵢ(t) and vₖ(t) which can represent the beginning and end of a scenario, with specific statistics that can be maintained for more or less time than in other scenarios at different times; for what you have:
$${h}_{nsc} ( t ) = {\sum }_{i = - ∞}^{∞} {y}_{i} ( t ) {w}_{i} ( t - α ) + {\sum }_{k = - ∞}^{∞} {y}_{k} ( t ) {v}_{k} ( t - α ) ,$$
where the windows wᵢ(t) and vₖ(t) must satisfy the condition
$${\sum }_{i = - ∞}^{∞} {w}_{i}^{2} ( t - α ) + {\sum }_{k = - ∞}^{∞} {v}_{k}^{2} ( t - α ) = 1 ,$$
and α is a random variable that in this case allows to smooth the transition between scenarios,
b) The initial phase α may or may not be considered from the time window as random; This would indicate that depending on where the mobile moves, the time window can start sooner or later,
c) The windows wᵢ(t) and vₖ(t) can take any form and duration, hence, the average power can remain constant satisfying the condition
$${\sum }_{i = - ∞}^{∞} {w}_{i}^{2} ( t - α ) + {\sum }_{k = - ∞}^{∞} {v}_{k}^{2} ( t - α ) = 1 ,$$
d) It can be considered different statistics and, therefore, different simulation parameters in each of the windows as desired,
e) In each time window the same method of generating channel realizations can be maintained as mentioned above.

8. Method according to claim 2, to emulate a non-WSS time-selective channel with time-varying instantaneous power by a controller that requires generating a Non-WSS channel from independent channel sequences with statistics that evolve over time, and that requires the consideration of the following points:
a) A non-stationary process h_{nsc}(t) with time varying power can be formed from the sum of two processes yᵢ(t) and yₖ(t) whose instant power varies over time σ_{y}²(t), is determined by the statistics defined in each window wᵢ(t) and vₖ(t) according to the index i- y k-window corresponding to a scenario; those windows wᵢ(t) and vₖ(t) they represent the beginning and end of a scenario with specific statistics with instantaneous power σ_{y}²(t), and which allow to reproduce the Lognormal behavior of a channel, so we have the model:
$${h}_{nsc} ( t ) = {\sum }_{i = - ∞}^{∞} {y}_{i} ( t ) {w}_{i} ( t - α ) + {\sum }_{k = - ∞}^{∞} {y}_{k} ( t ) {v}_{k} ( t - α ) ,$$
where the windows wᵢ(t) and vₖ(t) must meet a certain power profile variant over time
$${\sum }_{i = - ∞}^{∞} {w}_{i}^{2} ( t - α ) + {\sum }_{k = - ∞}^{∞} {v}_{k}^{2} ( t - α ) = {σ}_{y}^{2} ( t ) ,$$
and α it is a random variable that in this case serves to smooth the transition between scenarios,
b) The initial phase of the time window may or may not be considered as random; This would indicate that depending on where the mobile moves, the time window can start sooner or later,
c) The windows wᵢ(t) and vₖ(t) can take any form and duration, hence, the average power can remain constant satisfying the condition
$${\sum }_{i = - ∞}^{∞} {w}_{i}^{2} ( t - α ) + {\sum }_{k = - ∞}^{∞} {v}_{k}^{2} ( t - α ) = {σ}_{y}^{2} ( t ) ,$$
d) The statistics evolve over time as the ACF, PSD, LCR, ADF and, therefore, different simulation parameters according to the generation method in claim 2, are specified for each of the windows wᵢ(t) and vₖ(t) in all simulation time as desired,
e) In each time window the same method of generating channel realizations can be maintained as mentioned above.
